(19) United States
(12) Patent Application Publication
(10) Pub. No.: US 2011/0084148 A1
(43) Pub. Date: Apr. 14, 2011

(54) PLASTIC CARDS MADE FROM POST-CONSUMER PLASTIC

(76) Inventors: Roger H. Ricketts, Apple Valley, MN (US); John Tomczyk, Shoreview, MN (US)

(21) Appl. No.: 12/904,819

(22) Filed: Oct. 14, 2010

Related U.S. Application Data
(60) Provisional application No. 61/251,602, filed on Oct. 14, 2009.

(51) Int. Cl. G06K 19/06; B32B 3/00; B32B 3/10; G06K 19/067

(52) U.S. Cl. 235/492; 428/141; 428/195.1; 235/494; 235/493

(57) ABSTRACT

A plastic card, such as a credit card or gift card, manufactured from recycled polyethylene or recycled polypropylene, and methods of manufacturing the same. The plastic card is made from an unfilled or filled recycled polymeric material, such as a blend of virgin and recycled polyethylene or polypropylene, that can be readily printed, embossed, thermally imaged, surface printed with a variety of inks and printing methodologies, laminated, and/or polished, such that the card will perform acceptably in a retail point of sale machine readable activation system. The plastic card performs similarly to a traditional PVC card in retail point of sale systems or environments.

### RELATED APPLICATIONS

The present application claims the benefit of U.S. Provisional Application No. 61/251,602 entitled “PLASTIC CARDS MADE FROM POST-CONSUMER PLASTIC AND METHODS OF MAKING SAME,” filed Oct. 14, 2009, which is hereby incorporated by reference in its entirety.

### FIELD OF THE INVENTION

The present invention relates generally to plastic cards, such as transaction, information, identification, and stored value cards. More particularly, the invention relates to a plastic card, such as a credit card or gift card, manufactured from recycled polymeric materials, such as recycled polyethylene or recycled polypropylene, that can be printed, polished, and/or imaged while meeting or exceeding industry standards for transaction cards.

### BACKGROUND OF THE INVENTION

Plastic cards are used frequently in everyday commerce and are becoming more prevalent in a variety of applications. Plastic cards can include transaction, information, identification, and/or stored value cards, such as, for example, credit cards, debit cards, gift cards, phone cards, identification cards or badges, driver licenses, key cards, break-off cards with attached key fobs, lenticular cards, and any of a variety of other cards. The plastic cards can include printed indicia, such as a card number, pin number, identification information, name, address, expiration date, patent numbers, disclaimers, financial institution, store information, and/or the like. Further, plastic cards, such as financial transaction cards, can comprise a magnetic stripe or RFID chip that is adhered, embedded, or embossed on the card. The magnetic stripe or its equivalent is encoded with the card information and/or account information.

As the number of cards being produced increases, the amount of scrap material resulting from processing plastic cards and from discarded plastic cards themselves continues to increase. Plastic cards are typically manufactured using a polymeric material such as polyvinyl chloride (PVC) or styrene. These materials provide the desired properties and characteristics of the plastic cards, such as, for example, rigidity, durability, and price. One example of a desired property or characteristic would be that credit cards must meet certain ISO standards, such as, for example, standards for unused cards including ISO/IEC 7810:2003 entitled “Identification Cards—Physical Characteristics,” ISO/IEC 7813:2001 entitled “Identification Cards—Financial transaction cards” and ISO/IEC 7816.1:1987(E) entitled “Identification Cards—Integrated circuit(s) cards with contacts,” and standards for returned cards including ISO 7811-2:2001 and 7811:6:2001, all of which are incorporated herein by reference.

However, materials such as PVC and styrene have certain negative qualities; for instance, they are perceived as being not environmentally friendly in that they do not biodegrade readily and have no established recycling stream. PVC, for example, raises environmental concerns with the use of vinyl chloride, phthalate plasticizers, and dioxin when such material is burned. Furthermore, PVC and polystyrene are made from either crude oil or natural gas, and can therefore be subject to price fluctuations of oil, and depend on foreign oil supplies.

Recently, there has been a trend to adopt “green” materials, products, and practices. Green materials are materials that have a lesser impact on the environment in a variety of ways including reducing the amount of material used, reusing or recycling the material, using material that is renewable, is biodegradable, is biocompostable, is sustainable, is inert in a landfill environment, contains no toxins in its manufacture, is locally produced, and/or leaves a lower carbon footprint.

Green plastics are those plastics that possess at least some of the characteristics listed above. Such plastics can include, for example, glycol-modified polyethylene terephthalate (PETG), polylactic acid (PLA), polyhydroxyalkanoate polymers (PHA), starch, recycled paper, polypropylene, high density polyethylene (HDPE), recycled PVC, bio-styrene and -PVC (additives to impart biodegradable characteristics), cellulose acetate, and recycled paper with biodegradable laminate.

These green plastics can be generally organized into three categories: biomaterials, oxo plastics, and recycled content. The biomaterials, or those derived from natural sources such as sugar-based sources like corn, flax, beets, sugar cane, soybeans, and/or the like, include PLA, PHA, and Cereplast™-brand renewable plastics. The oxo plastics can include plastics that contain an oxo oil additive as part of liquid stabilizer compositions, for example oxo-PVC and oxo-styrene. Recycled content are materials that have been recycled and reused such as, for example, r-PVC, r-styrene, and r-APET.

Steps have been taken to manufacture environmentally friendlier plastic cards, such as credit cards, using materials such as PETG and PLA. See, for example, http://www.treehugger.com/files/2006/08/triodos_eco_cre.php and http://blog.tmcnet.com/green-blog/green-credit-card-to-help-reduce-carbon.asp. Further, some recycled plastics have been used to make plastic cards, as described in U.S. Application Publication No. 2007/0243362, entitled “Sheet Stock and Cards Made From Recycled Plastic Scrap Material and Methods.” However, these materials in the case of PETG and PLA and/or methods of using recycled materials from the card manufacturing waste stream may be cost restrictive, require additional processing steps for sufficient printing, embossing, polishing characteristics, and have been perceived by some as not being green material, such as in the case of PVC, and/or may lack sufficient characteristics to create a product that meets the ISO standards for such cards.

Recycled polyethylene, although more abundant, poses problems when used for stored-value or transaction cards, because of its pliability or flexibility as compared to PVC and PLA materials. The pliability can lead to difficulties in applying machine readable features such as magnetic stripes, can affect the adhesion or surface profile of the magnetic stripes negatively, can cause printing adhesion issues, and/or can have negative visual effects, such as black flecks throughout due to contamination of the recycled content.

A need has arisen for a cost-efficient, recycled plastic card that meets the requirements of printing, press polishing, magnetic stripe application, imaging, and/or encoding while meeting many of the characteristics of the current ISO specification for card and imaging encoding.

### SUMMARY OF THE INVENTION

The present invention resolves many of the above-described deficiencies and drawbacks inherent with both currently used, non-“green” plastics, and the “green” plastics mentioned above. In embodiments of the invention, a plastic card, such as a transaction card, is fabricated from a polymeric material comprising a filled or unfilled post-consumer plastic such as recycled polyethylene or polypropylene material or blends thereof.

The plastic card can be manufactured from recycled materials without compromising performance such that it performs similarly to a traditional PVC card that can be activated at retail point of sale systems or environments. The post-consumer plastic material provides sufficient glossiness, durability and tear resistance to meet industry and/or many of the requirements of the ISO 7810:2003 specification for card manufacturing, ISO 7811-2 or ISO 7811-6 standards for magnetic stripe specification, including ISO 7811-2:2001 and 7811:6:2001 that are applicable for returned cards, and can be readily printed, embossed, thermally imaged, surface printed with a variety of inks and printing methodologies, laminated, and/or polished, such that the card will perform acceptably in a retail point of sale system. Further, the plastic card of the present invention is manufactured at a lower cost and lower shipping weight than traditional PVC cards.

A method of making such a card can include extruding a blend of virgin and recycled polymeric material, filled or unfilled, such as a low density polyethylene, high density polyethylene, low linear polyethylene, high molecular weight polyethylene, polypropylene, and combinations thereof, into a sheet stock, cooling the extruded material to room temperature, optionally treating the sheet by corona, laser, or flame-treating, and/or by applying an optional coating such as a primer or the like, imaging the sheet by way of surface printing techniques, digital printing, thermal printing, thermal imaging, embossing, and/or the like, applying a coating over the printed surface of the sheet, optionally polishing the sheet by press-polishing methods, optionally encoding the sheet with a magnetic stripe, RFID, or bar code, and post-processing the finished sheet such as converting to form a card, packaging, shipping, and/or the like.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a front view depicting a card according to an embodiment of the invention.

FIG. 2 is a rear view of the card of FIG. 1.

FIG. 3 is a flow chart according to an embodiment of the invention.

FIG. 4 is a cross-sectional view of a card according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

In various embodiments of the invention, a plastic transaction card is fabricated using post-consumer plastic, such as, for example, recycled polypropylene, and recycled polyethylene including high density polyethylene (HDPE) and low density polyethylene (LDPE). These “green” plastics are abundantly available because they are frequently used to make everyday products and there are well established recycling streams for the discarded products. For example, polyethylene is often used to make items such as cups, food containers, bags, films, and the like. In particular, industry has recognized HDPE as the plastic container of choice to ensure purity of its contents. For example, plastic milk containers, the non-clear variety of water jug, opaque vitamin and medicinal products, laundry detergent bottles, and fuel tanks in automotive vehicles are all typically fabricated from HDPE. The number 2 in the middle of the triangle of arrows that make up the recycle logo can be found on the bottom of most HDPE containers, indicating its specific recycling stream.

These materials are also less dense than standard PVC and polystyrene, which results in less weight and lower freight cost, ultimately resulting in a lower cost per sheet than other materials. For example, the density of unfilled polyethylene (HDPE) and unfilled polypropylene is about 0.90-0.96 grams/cm³ whereas the density of unfilled PVC is about 1.35-1.41 grams/cm³, and the density of unfilled polystyrene is about 1.03-1.05 grams/cm³.

However, virgin and recycled polyethylene or propylene and blends thereof are difficult to print, emboss, polish and/or otherwise process to meet industry standards for plastic cards. The inventors have found processing steps that promote adhesion characteristics and reduce surface roughness of the polyethylene material, as well as create an appealing visual aesthetic, which will be described in more detail below.

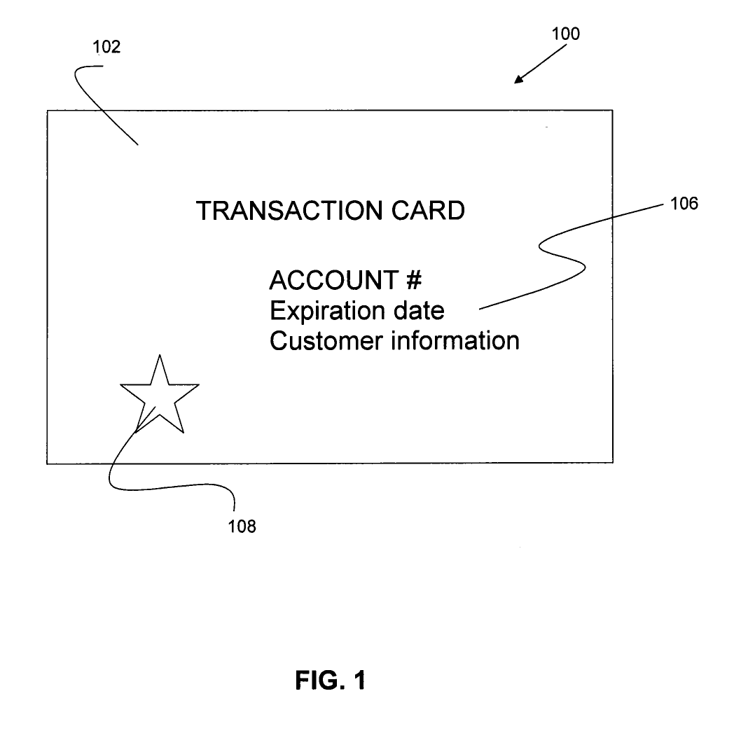

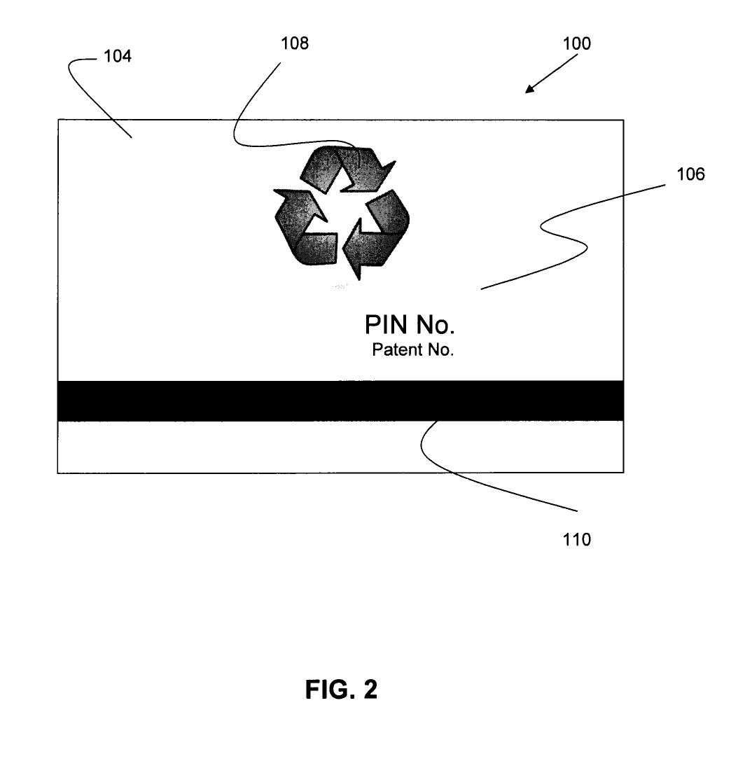

Referring to FIGS. 1 and 2, a plastic card 100 fabricated from post-consumer plastic according to embodiments of the invention generally can comprise a first side 102, a second side 104, printed indicia 106, optional graphics 108, and an information carrier 110, such as, for example, a magnetic stripe, barcode, RFID, or the like. In one embodiment of the invention, plastic card 100 can comprise a transaction card or stored value card such as, for example, a credit card, debit card, phone card, gift card, rental card, hotel key passes, or any of a variety of transaction cards or stored value cards. In another embodiment of the invention, plastic card 100 can comprise an identification card, such as, for example, an insurance card, driver's license, security badge, membership card, key card, and other suitable identification cards. In yet another embodiment of the invention, plastic card 100 can comprise an informational or promotional card, such as, for example, a coupon, business card, sports cards, game cards, loyalty cards and other informational or promotional cards. In one embodiment of the invention, plastic card 100 can comprise at least one break-off section comprising a key fob, coupon, panels including a one-piece snap off, or the like.

Plastic card 100 is fabricated from one or more suitable “green” materials, such as, for example, a base material containing recycled content, such as recycled polyethylene or polypropylene. The base material can comprise 100 percent post-consumer material, i.e. one or more recycled plastics, or a blend of one or more virgin materials and one or more recycled materials. Recycled content of the card can range from about 1 to about 99 percent by weight. In one embodiment of the invention, plastic card 100 is fabricated from a blend of 70 weight percent virgin HDPE, and 30 weight percent recycled HDPE. In some embodiments, the virgin and recycled materials are the same polymeric materials, and in other embodiments, the virgin and recycled materials are different, yet compatible, polymeric materials.

In some embodiments of the invention, the polymeric base material can further comprise a filler. The polymeric base material can be filled with materials such as, for example, talc, calcium carbonate, titanium dioxide, ash, glass beads, glass fibers, starch, minerals, paper, and other suitable fillers and combinations thereof. The fillers impart certain characteristics on the polymeric material such as durability, impact strength, heat stability, visual aesthetic (e.g. brightness), and/or the like. A filler can also be chosen depending on the base material. For example, talc and calcium carbonate are compatible with polyolefins such as polyethylene and polypropylene. A filler can also be based on the amount of recycled content in the base material. For example, if the base material comprises a high content of recycled content such as fifty weight percent or more, titanium dioxide can be added to brighten the base material such that negative black flecks are unnoticeable or reduced.

In one embodiment of the invention, the filler is present in an amount from about five percent to about fifty percent by weight. In another embodiment of the invention, the filler is present in an amount from about ten to about thirty percent by weight.

Plastic card 100 can be opaque, semi-opaque, or transparent depending on the polymeric material, level of recycled content, and whether a filler is present. In one embodiment of the invention, the polymeric base material can comprise a pigment in one or both of the virgin and recycled content such that the resulting card is pigmented. In another embodiment, pigment is added to the base material at one or more steps in extrusion process.

Plastic card 100 exhibits similar performance characteristics to standard cards made from PVC, polystyrene, and/or the like. Plastic card 100 can be encoded, embossed, printed, stamped, polished and/or otherwise processed while exhibiting suitable characteristics to be used in retail point of sale applications. For example, plastic card 100 can be surface printed exhibiting satisfactory printing adhesion. Plastic card 100 can be printed with printed indicia 106 and/or graphics 108 on either first side 102, second side 104 or both. The printing can be accomplished by digital and conventional printing processes such as, for example, lithography, flexography, inkjet printing such as continuous and drop on demand technologies, screen printing including silk screen, gravure, rotogravure, dye sublimation printing, thermal transfer, xerographic printing including laser printing and digital toner-based printing, and/or other suitable printing methodologies.

Printed indicia 106 can comprise text, pictures, drawings, symbols, and/or other indicia that can be printed on a substrate. Such indicia 106 can include, for example, customer name, address, account number, source information such as store or institution information, pin numbers, expiration date, patent and/or other intellectual property markings, terms and conditions, customer service information, graphics such as the recycle logo, and any of a variety of suitable printed indicia.

Printed indicia 106 can comprise curable inks and toners in a variety of colors and effects, such as a metallic appearance, in one embodiment, although non-curable inks may be used in embodiments. Suitable inks, toners, or surface printing materials can comprise, for example, radiation curable inks such as UV-curable or e-beam curable inks or pastes, thermal inks or toners, solvent-based inks such as an MEK system or a water-based system, solvent-less inks or pastes, colloidal inks or pastes, and/or any other suitable ink or printing material. In one embodiment of the invention, card 100 is printed with a UV curable ink using ink jet drop on demand technology.

Ink adhesion issues that can result when printing on polyethylene, including recycled polyethylene, can be overcome by adding primers to the area to be printed, and/or altering the surface condition by surface treatment. Plastic card 100 can also be pretreated before printing. The addition of primers and/or the surface treatment can be accomplished either inline or offline in separate process(es). In one embodiment of the invention, plastic card 100 can be surface treated to promote ink adhesion. Surface treatments can comprise corona treating, plasma treating, and/or flame treating.

In another embodiment of the invention, plastic card 100 can be coated with a coating, such as a primer or other coating, to promote ink adhesion. Such coatings can include radiation curable coatings such as UV-curable or e-beam curable coatings, in either a solvent-based or solvent-less form. One suitable material is a 100% solids, UV-curable acrylate oligimer/monomer blend, commercially available as Thermal Ink Receptive UV RV-4865E, available from both Spring Coating Systems of Jungholtz, France and Performance Coating Corporation in Levittown, Pa. Such coatings can be used alone or in combination with the surface treatments described above.

Plastic card 100 can also be further imaged by processes such as, for example, thermal imaging, solvent inkjet, UV inkjet, embossing, laser imaging, hot stamping, foil stamping, and/or other suitable imaging techniques to form, for example, graphics 108.

An optional coating can be applied over at least a portion of first side 102 and/or second side 104 to at least partially cover any printed indicia 106 and/or graphics 108. One such suitable coating can comprise a UV coating, such as Henkel 14-88N230, which is subsequently cured by exposure to UV. The UV coating can be a conducive to further process such as, for example, hot stamping, additional printing, and/or other such processing steps.

Other attributes can be added to printed card 100 on first side 102 and/or second side 104 of card 100 as desired, such as a machine readable feature 110 including magnetic striping, RFID, contact chips, contactless RFID, bar coding, encrypted bar coding, signature panels, and/or other identifiers and/or indicia, as depicted in FIG. 2. In one embodiment of the invention, machine readable feature 110 comprises a magnetic stripe applied by a hot stamping process that is subsequently encoded with account information. In an alternative embodiment of the invention, methodologies for providing a bar code can include, for example, thermal imaging, DOD inkjet printing, solvent inkjet printing techniques, and/or other suitable printing techniques as described above. Such imaging and encoding should meet industry standards such as, for example, ANSI 182-1990, ISO 7811-2, and ISO 7811-6 for imaging and encoding, all of which are incorporated by reference.

In compliance with ISO 7811-2, and to ensure a functioning magnetic stripe or other machine readable indicia, the area in which machine readable feature 110 (such as a magnetic stripe) is applied should comprise an average surface roughness (Rₐ) of about 0.40 μm (15.9 μin) or less in both the longitudinal and transverse directions of the area as set forth on page 7 of the ISO standard, for example. The average surface roughness (Rₐ) is an amplitude parameter, and is an arithmetic average of the absolute values of the vertical deviations of the roughness profile from the mean line. This surface roughness can be measured using profilometric techniques including the use of a contactless method involving an optical or laser stylus, or a contact or stylus-based method involving a diamond stylus or the like in contact with the sample to be measured. The ISO standard for measuring the surface roughness is set forth in ISO 4287, and is incorporated herein by reference in its entirety.

In addition to surface roughness, a surface profile of the magnetic stripe area, or as defined on page 5 of ISO-7811-2, the vertical deviation of the transverse surface profile of the magnetic stripe area, should comprise limits between 4.5 μm (175 μin) and 15.4 μm (607 μin), the ranges of which depend on the bending stiffness values of card 100 and whether the feature 110 is concave or convex when applied to card 100, as set forth on pages 5-6 of ISO-7811-2.

In order to ensure an adequately smooth surface to apply machine readable feature 110, the inventors have found that the initial card material forming card 100 must be sufficiently smooth. A porcelain-like finish, which is a high gloss finish, of card 100 is obtained by casting the polymeric base material onto an equally smooth roll or rolls in the extrusion process.

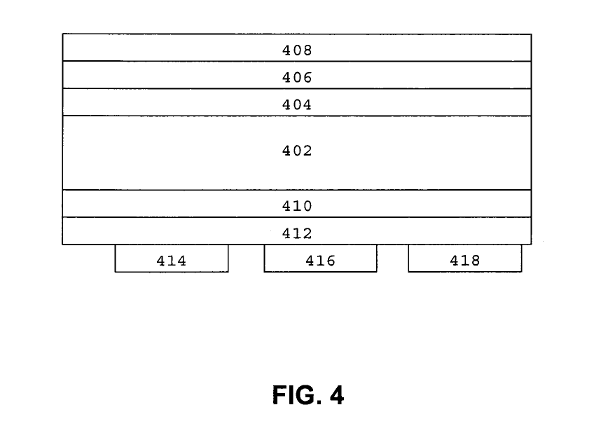

In a particular embodiment of the invention and referring to FIG. 4, plastic card 100 comprises a polymeric core 402 fabricated from a polymeric base material containing recycled content. Core 402 can be about 5 to about 40 mils in thickness, and more particularly about 30 mils. A first, front side of card 400 comprises a primer layer 404 over at least a portion of first surface of core 402, a an ink layer 406 over at least a portion of primer layer 404 to form printed indicia 106 and/or graphics 108, and a coating 408 over at least a portion of ink layer 406. A second, back side of core 402 comprises a primer layer 410 (of the same or different type as primer layer 404) over at least a portion of core 402, an ink layer 412 over at least a portion of primer layer 410 forming text, a coating 414 over ink layer 412, a magnetic stripe 416 applied to coating 414, and a barcode 418 applied to coating 414. An optional scratch-off portion 418 can be added, such as a concealing layer for a human-readable number.

To further promote characteristics such as adhesion and imaging properties, plastic card 100 can be polished. Plastic card 100 can be press-polished before and/or after printing or imaging. Press-polishing, or planishing, is a finishing process to impart high gloss, improved clarity, and/or improved mechanical properties. Plastic card 100 is hot pressed against thin, highly polished metal plates. Other suitable polishing techniques can also be used alone, or in combination, with press-polishing. In one embodiment of the invention, first side 102 and/or second side 104 of plastic card 100 is press-polished. An optional coating (414) can be applied before press polishing to ensure protection of any printed indicia 106 and/or graphics 108.

In one embodiment of the invention, plastic card 100 can be laminated, adhered, fused, and/or the like to other substrates or materials to create a laminated card. In one embodiment, plastic card 100 is combined with a lenticular lens to produce a lenticular card. The lenticular lens can also be manufactured using a green polymer, such as polypropylene, polyethylene, polylactic acid, and/or the like. In another embodiment, plastic card 100 can comprise a laminate over one or both surfaces of plastic card 100. The laminate can comprise, for example, a clear material formed from the same polymeric material as the base material of plastic card 100, or can be formed form a different polymeric material, such as another green material.

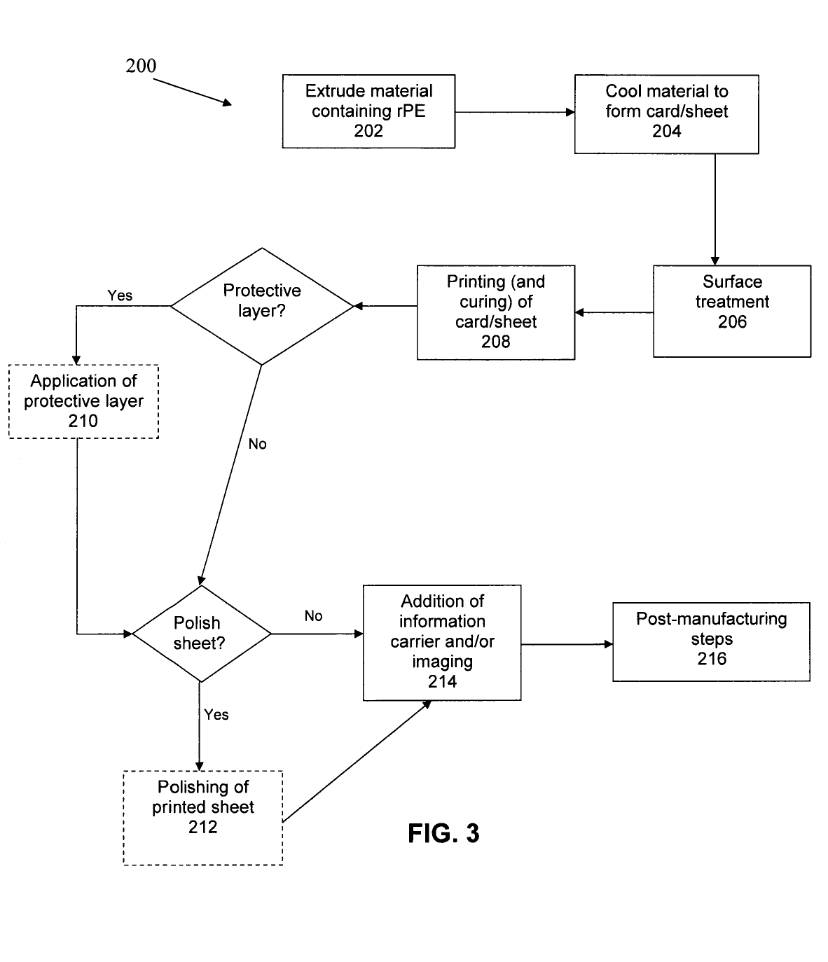

Referring now to FIG. 3, a method 200 for manufacturing plastic cards is shown according to embodiments of the present invention. In one embodiment of the invention, a base polymeric material (polyethylene and/or polypropylene) containing recycled content is extruded at step 202 using standard extrusion techniques. The extruded material is formed and cooled into sheet stock at step 204. The extruded sheet stock is then optionally surface treated at step 206 using corona treatment, plasma treatment, flame treatment, and/or the like, or combinations thereof. In an alternative embodiment, an optional coating, such as an adhesion promoter or primer (layers 404 and 410) as described above, is applied to at least a portion the sheet stock. The optional coating can be accomplished by standard methods such as, for example, roll coating, curtain coating, spray coating, litho printing, and/or the like. If needed, the primer can be cured using one or more curing stations such as UV, IR, e-beam, thermal, and/or the like stations.

One or more surfaces of the sheet stock (with or without primer) are then printed at step 208 using any of a variety of printing techniques described supra to form ink layers 406 and 412. One or more printing stations can be used alone or in combination to print at least a portion of the sheet stock. Optional curing stations, such as UV, IR, e-beam, thermal, and/or the like stations, can be used to cure the printing inks or materials.

An optional coating or protective layer (layers 408 and 414) can be applied at step 210 over the first surface, the second surface, or both to protect any printed indicia. Such coating can include, for example, a radiation-curable coating, such as a UV-coating that is printable, hot-stampable, embossable, or the like. In one embodiment of the invention, the optional coating is a UV-curable material that is subsequently exposed to UV light to cure the coating, thereby forming the protective layer.

One or more surfaces of the printed sheet stock can then be optionally polished at step 212, such as press-polished, to improve the gloss for improved downstream processability.

One or more machine readable features (416), such as a magnetic stripe, barcode, or RFID, and/or human-readable features 418, such as a scratch-off portion, are optionally applied in step 214 to one or more surfaces of the sheet stock by means of hot stamping, printing, laminating, and/or other suitable means of applying. In one embodiment of the invention, machine readable feature comprises a magnetic stripe that can be extruded onto the sheet stock. The magnetic stripe has a profile, or as defined on page 5 of ISO-7811-2, the vertical deviation of the transverse surface profile of the magnetic stripe area from about 150 to about 650 μin, and more particularly from about 200 to about 400 μin.

In other embodiments of the invention, an optional magnetic stripe can be applied to the sheet stock at any time in the process such as, for example, prior to printing, after printing, and/or on individual cards after converting the sheet stock. In one particular embodiment of the invention, one or more magnetic stripes can be applied to a sheet of cards pursuant to U.S. Pat. No. 6,481,994 entitled “Apparatus for Making a Magnetically Readable Card,” U.S. Pat. No. 6,964,810 entitled “Magnetically Readable Card and a Method of Making a Magnetically Readable Card,” and U.S. Pat. No. 7,300,535 entitled “Magnetically Readable Card and a Method of Making a Magnetically Readable Card,” all of which are incorporated herein in their entirety.

The sheet stock is then optionally imaged using thermal, laser, embossing, and/or the like in step 214. For example, a drop on demand barcode (418) can be applied to one of the surfaces in this step. The imaging and encoding can be conducted in the same processes step. If a hot stamp unit is placed in front of the encode unit, the magnetic stripe (416) can be applied to individual cards directly before encoding.

Post processing step 216 can include, for example, converting, collating, packaging, additional coatings, such as protective coatings, laminating, and/or any of a variety of post-processing steps. In one embodiment of the invention, the filled polypropylene material is extruded as sheet stock in step 202. The sheet stock is converted to suitable sizes according to industry standards, so as to form a card such as, for example, a CR80, M6E, or M6 card. A CR80 card is a standard card size having dimensions of about 3.375″×2.125″ (85.6 mm×54 mm). An M6E is a standard card size having dimensions of 3⅜″×5¼″ without a snap-off feature, and an M6 card is a standard card size having dimensions of 3⅜″×4⅞″ with a snap-off feature created by die-lines.

The method of manufacture is not limited to the sequence of steps as depicted in FIG. 3. Other flow paths can include after the extrusion step, for example: (1) printing of sheets, cutting out cards, applying information carrier(s), followed by imaging and/or encoding of the cards; (2) applying information carrier(s) to full sheets, printing of sheets, cutting cards, followed by imaging and/or encoding cards; (3) printing of sheets, applying information carrier(s) to the sheets, cutting out cards, followed by imaging and/or encoding cards; (4) printing of sheets, cutting out cards, applying information carriers to the cards, followed by imaging and/or encoding the cards in the same process step; and/or (5) printing of sheets, press-polishing and apply information carriers simultaneously, cutting the cards, followed by imaging and/or encoding the cards. In alternative embodiments, some or all cards may omit the encoding step. All contemplated flow paths can be used in manufacturing of the plastic cards.

### EXAMPLE 1

A number of cards were produced using a polyethylene core sheet containing at least 30 percent by weight recycled polyethylene available from PolyPrime/Imperial of Crawfordsville, Ind., having a thickness of about 29-30 mils, and having a fine matte finish on both sides. A primer was applied to both sides of the core. The first or front side of the core having the primer layer thereon was printed using a 4-color process with UV-curable inks, specifically 4 cp Flint lamination ink, that were subsequently cured. A UV-curable coating, specifically RV-4865 UV coating available from Performance Coatings, was applied over the ink layer and subsequently cured.

The back side of the core having the primer layer thereon was printed with a black UV-curable ink, specifically black Flint lamination ink, that was subsequently cured to form text. A UV-curable coating, specifically RV-4865 UV coating, was applied over the printed layer and was subsequently cured. A 2-track LoCo magnetic stripe (#312-5007) was applied to the UV coating layer by hot stamping. A barcode was also applied to the UV coating layer by either drop-on-demand printing technology on some cards, or inkjet technology on some cards, using a methyl ethyl ketone-(MEK) based ink.

The resulting cards were tested using both unused and returned card specifications and all cards passed or exceeded at least the returned card specifications set forth in the ISO specifications 7811-2 and 7811-6 listed above.

A plastic card according to the embodiments of the invention can reduce the negative impacts on the environment that standard PVC or polystyrene cards create. The plastic card of the present invention is fabricated from post-consumer materials and may additionally be readily recyclable in that materials are used that have established recycling streams. Further, the materials used to manufacture the plastic cards of the present invention cost less, are less dense, and can be locally supplied. The plastic cards of the present invention meet many of the industry standards, and perform similar to the standard PVC or polystyrene cards in retail point of sale applications.

The plastic cards of the present invention provide further advantages to traditional PVC and polystyrene transaction cards. For example, recycled polyethylene and polypropylene blends can exhibit more durable behavior than PVC and polystyrene, and tend to be more resistant to tearing, having a higher tear strength than either PVC or polystyrene.

The invention therefore addresses and resolves many of the deficiencies and drawbacks previously identified. The invention may be embodied in other specific forms without departing from the essential attributes thereof; therefore, the illustrated embodiments should be considered in all respects as illustrative and not restrictive.

What is claimed is:

1. A plastic card fabricated from post-consumer plastic, the plastic card comprising:
a polymeric substrate, wherein the polymeric substrate is at least partially fabricated from a post-consumer polymeric material;
a surface treatment applied to at least one of a first and second surface of the substrate;
a printed layer deposited on at least a portion of a substrate having the surface treatment applied thereto; and
a machine readable feature deposited on the first surface, wherein an area of the first surface having the machine readable feature thereon has an average surface roughness of about 0.40 μm or less in at least one of a longitudinal and transverse direction of the area.

2. The plastic card according to claim 1, wherein the post-customer material comprises high density polyethylene, low density polyethylene, low linear polyethylene, high molecular weight polyethylene, and combinations thereof.

3. The plastic card according to claim 2, wherein the substrate is fabricated from a base resin including a post-consumer polyethylene material blended with a virgin polymeric polyethylene material.

4. The plastic card according to claim 3, wherein the post-consumer polyethylene material comprises from about 10 to about 50 percent by weight of the base resin.

5. The plastic card according to claim 1, wherein the surface treatment comprises a corona treatment, a plasma treatment, a flame treatment, a laser treatment, a primer layer, and combinations thereof.

6. The plastic card according to claim 1, wherein the machine readable feature comprises a magnetic stripe, barcode, contact chip, contactless RFID, and combinations thereof.

7. The plastic card according to claim 1, further comprising:
a protective layer formed over at least a portion of the printed layer.

8. The plastic card according to claim 7, wherein the at least one of the first major surface and second major surface having the protective layer is press-polished.

9. A plastic card fabricated from post-consumer plastic, the plastic card comprising:
a polymeric substrate, wherein the polymeric substrate is at least partially fabricated from a post-consumer polyethylene material;
a surface treatment applied to at least one of a first and second surface of the substrate; and
a printed layer deposited on at least a portion of a substrate having the surface treatment applied thereto.

10. The plastic card according to claim 9, wherein the post-customer polyethylene material comprises high density polyethylene, low density polyethylene, low linear polyethylene, high molecular weight polyethylene, and combinations thereof.

11. The plastic card according to claim 9, wherein the substrate is fabricated from a base resin including the post-consumer polyethylene material blended with a virgin polyethylene material.

12. The plastic card according to claim 11, wherein the post-consumer polyethylene material comprises from about 1 to about 99 percent by weight of the base resin.

13. The plastic card according to claim 12, wherein the post-consumer polyethylene material comprises from about 10 to about 50 percent by weight of the base resin.

14. The plastic card according to claim 11, wherein the virgin polyethylene material is the same polyethylene material as the post-consumer polyethylene material.

15. The plastic card according to claim 11, wherein the virgin polyethylene material is a different polymeric material from the post-consumer polyethylene material.

16. The plastic card according to claim 9, wherein the surface treatment comprises a corona treatment, a plasma treatment, a flame treatment, a laser treatment, a primer layer, and combinations thereof.

17. The plastic card according to claim 9, further comprising:
at least one machine readable feature deposited on at least one of the first surface and the second surface of the substrate, wherein an area of the first surface having the machine readable feature thereon has an average surface roughness of about 0.40 μm or less in at least one of a longitudinal and transverse direction of the area, and wherein the at least one machine readable feature comprises a magnetic stripe, barcode, contact chip, contactless RFID, and combinations thereof.

18. The plastic card according to claim 9, wherein the polymeric substrate is opaque or semi-opaque.

19. The plastic card according to claim 9, further comprising:
a protective layer formed over at least a portion of the printed layer on at least one of the first major surface and the second major surface.

20. The plastic card according to claim 19, wherein the at least one of the first major surface and second major surface having the protective layer is press-polished.

21. A sheet for forming a plurality of cards therefrom, the sheet comprising:
a polymeric substrate, wherein the polymeric substrate is at least partially fabricated from a post-consumer polyethylene material;
a surface treatment applied to at least one of a first and second surface of the substrate; and
a printed layer deposited on at least a portion of a substrate having the surface treatment applied thereto.

22. The sheet according to claim 21, wherein the post-customer polyethylene material comprises high density polyethylene, low density polyethylene, low linear polyethylene, high molecular weight polyethylene, and combinations thereof.

23. The sheet according to claim 21, wherein the substrate is fabricated from a base resin including the post-consumer polyethylene material blended with a virgin polyethylene material.

24. The sheet according to claim 23, wherein the post-consumer polyethylene material comprises from about 1 to about 99 percent by weight of the base resin.

25. The sheet according to claim 24, wherein the post-consumer polyethylene material comprises from about 10 to about 50 percent by weight of the base resin.

26. The sheet according to claim 21, wherein the surface treatment comprises a corona treatment, a plasma treatment, a flame treatment, a laser treatment, a primer layer, and combinations thereof.

27. The sheet according to claim 21, further comprising:
at least one machine readable feature deposited on at least one of the first surface and the second surface of the substrate, wherein an area of the first surface having the machine readable feature thereon has an average surface roughness of about 0.40 μm or less in at least one of a longitudinal and transverse direction of the area, and wherein the at least one machine readable feature comprises a magnetic stripe, barcode, contact chip, contactless RFID, and combinations thereof.

28. The sheet according to claim 21, wherein the polymeric substrate is opaque or semi-opaque.

29. The sheet according to claim 21, further comprising:
a protective layer formed over at least a portion of the printed layer on at least one of the first major surface and the second major surface.

30. The sheet according to claim 21, wherein the at least one of the first major surface and second major surface having the protective layer is press-polished.
